(19) United States
(12) Patent Application Publication
(10) Pub. No.: US 2010/0122289 A1
(43) Pub. Date: May 13, 2010

(54) Portable Client-Side Settings for a Multimedia Content Distribution Network

(75) Inventors: Daniel George Jean, Atlanta, GA (US); Bryan Davis, San Antonio, TX (US); Mary Catherine McCarthy, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/267,899

(22) Filed: Nov. 10, 2008

(51) Int. Cl. H04N 7/173; G06F 3/00

(52) U.S. Cl. 725/37; 725/100

(57) ABSTRACT

A disclosed portable settings service for use in conjunction with a multimedia content distribution service includes enabling a user to define settings for aspects of a multimedia content delivery network (MCDN) client. The service may include storing the defined settings to a settings file. The service may further include enabling the user to designate any of a set of multiple MCDN clients and, in response, applying the settings in the settings file to the designated MCDN client. In some embodiments, the settings application operates in conjunction with a user interface that enables the user to modify the defined settings. The user interface enables the user to modify the defined settings while interacting with a first customer premises equipment (CPE). Enabling the user to designate any of a plurality of MCDN clients may include, in some embodiments, enabling the user to designate a second CPE that is different than the first CPE.

### BACKGROUND

1. Field of the Disclosure

The present disclosure relates generally to the field of multimedia content and, more specifically, services and networks for delivering multimedia content and associated features to end users.

2. Description of the Related Art

A user of a multimedia content delivery service may spend significant time defining viewing settings that are customized to the user's preferences. At the same time, a user may be highly mobile and may have the ability to communicate with other users.

### BRIEF DESCRIPTION OF THE DRAWINGS

FIG. 1 is a block diagram of selected elements of an embodiment of a multimedia content delivery network;

FIG. 2 is a block diagram illustrating additional detail of an embodiment of a client of the network of FIG. 1;

FIG. 3 is a block diagram of selected elements of an embodiment of customer premises equipment;

FIG. 4 depicts selected elements of an embodiment of a user interface for defining user settings;

FIG. 5 is a flow diagram depicting selected elements of an embodiment of a service enabling users to define settings for clients in networks such as the network of FIG. 1; and

FIG. 6 is a flow diagram of an embodiment of a method of implementing a user settings service in a network such as the network of FIG. 1.

### DESCRIPTION OF THE EMBODIMENT(S)

Disclosed subject matter enables users to multimedia content delivery services to replicate the settings from their home TV to their vacation home or to a family member's TV. Users do have to worry about a set top box replacement causing a loss of all of their settings. The disclosed subject matter also addresses the ease with which settings among the Internet protocol Television (IPTV) community are exchanged.

The disclosed subject matter encompasses an application that may assemble relevant client-side settings such as: Favorite channels and favorite guides, Parental control settings, Mosaic channel settings, Home channel settings, digital video recorder (DVR) settings, Core IPTV settings, Appearance Skins (background images, color schemes) or Themes. Users would have the ability to select which setting or settings they want to export. For example, users may only want to export DVR series settings and nothing else, or, users may want a full export. Once the user defines the applicable settings, the disclosed application captures the settings and saves them to a standardized settings file, referred to herein as a multimedia content delivery network (MCDN) client settings file. The MCDN client settings file can be saved either to a local set top box or other type of customer premises equipment (CPE). In addition, the MCDN client settings file can be saved on the application server in the network. A user might further have the ability to name and distribute the MCDN settings file using on screen messaging (email, text messaging, instant messaging, etc). Another user or another designated recipient can download the setting files and, using the application, request that the settings be imported. Once the MCDN client settings are imported, the settings might be presented to the receiving user as a list. The user might be able to pick and choose which of the defined settings to apply to their MCDN client implementation. The MCDN client settings might then be applied to the user's client implementation.

In one aspect, a disclosed portable settings service for use in conjunction with a multimedia content distribution service includes enabling a user to define settings for aspects of a MCDN client. The service may include storing the defined settings to a settings file. The service may further include enabling the user to designate any of a set of multiple MCDN clients and, in response, applying the settings in the settings file to the designated MCDN client. In some embodiments, the settings application operates in conjunction with a user interface that enables the user to modify the defined settings. The user interface enables the user to modify the defined settings while interacting with a first CPE. Enabling the user to designate any of a plurality of MCDN clients may include enabling the user to designate a second CPE that is different than the first CPE.

The settings file may be stored to a networked or remote storage device or to CPE or local storage. A user may send the settings file to a designated MCDN client or to another destination via a messaging service of the multimedia content distribution (MCD) service. The messaging service may be an email service, an instant messaging service, a text messaging service, or another suitable service. The defined settings may include as examples, favorite channel settings, favorite guide settings, parental control settings, mosaic channel settings, home channel settings, DVR settings, and skin settings that are indicative of settings for background images and color schemes. In some embodiments, applying settings defined in the settings file may include applying a subset of the settings in the settings file.

In another aspect, a disclosed computer readable storage media includes computer executable instructions for implementing a portable preferences feature of an MCD service and network. The disclosed instructions may include instructions for defining settings, based on user input, that are indicative of client-side preferences for aspects of an MCD service and storing the defined settings to a settings file. Settings in the settings file may then be applied to a designated MCDN client. In some embodiments, the instructions may include instructions for generating and displaying a settings user interface. User interactions with the settings user interface are then performed to modify the settings. The settings may include favorite channel settings, favorite guide settings, parental control settings, mosaic channel settings, home channel settings, DVR settings, and skin settings.

Storing the defined settings to the settings file may include storing the defined settings to local storage of client-side CPE or to networked storage. In some embodiments, the designated client itself may be used to define the settings. In other embodiments, defining the settings is performed with a different client than the designated client or with a different type of resource entirely, e.g., the designated client encompasses a set top box and a user's desktop computer is used to define the settings, perhaps via a conventional web browser.

In another aspect, a disclosed portable settings feature of an MCD service includes enabling an MCDN client to download or otherwise receive a user settings application or module from an application server. The client may invoke the user settings module to define user preferences for various aspects of the client including, for example, preferences that define aspects of user interfaces, user settings, programming schedules, and so forth. The user preferences may then be stored to a settings file. If an application server or other type of network resource then receives an import settings request from a client, the network resource may then respond by downloading the settings file to a designated client, which may be the client device that issued the request or another client that is specified by the requester. The portable settings feature includes applying the settings defined in the settings file to the designated client.

In another aspect, disclosed CPE in an MCDN includes a network adapter for receiving multimedia content from the network and a multimedia decoder to decode multimedia content received from the network. The CPE may further include a processor and tangible computer readable storage media that is accessible to the processor. The storage media may include processor executable instructions to display a user settings interface.

The user settings interface may be operable to enable a user to specify user settings or user preferences for an MCDN client. The user settings interface may be configured to determine user settings specified for the MCDN client and to generate an MCDN settings file indicative of the user settings. The interface may further provide functionality for saving the MCDN settings file to storage, sending the MCDN settings file to a designated MCDN client, receiving an MCDN settings file from an originating client, and applying settings indicated in a received MCDN settings file to a designated client based on the settings in the settings file.

Saving the MCDN settings file to storage may include saving the MCDN settings file to fixed storage, such as the storage within a set top box or other type of client-side resource or the storage within or accessible to a networked server. In other embodiments, saving the file to storage may include saving the file to portable storage such as a flash drive. In flash drive embodiments, the defined settings may be applied to a designated client by plugging the flash drive into a peripheral port of the designated client.

The CPE may be encompassed within a set top box that receives multimedia content from an MCDN. The MCDN may represent an IPTV network. In some embodiments, the instructions for sending include instructions for sending the settings file to the specified client as an attachment to an electronic message in the form of an email, short messaging service message, or another suitable type of message.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

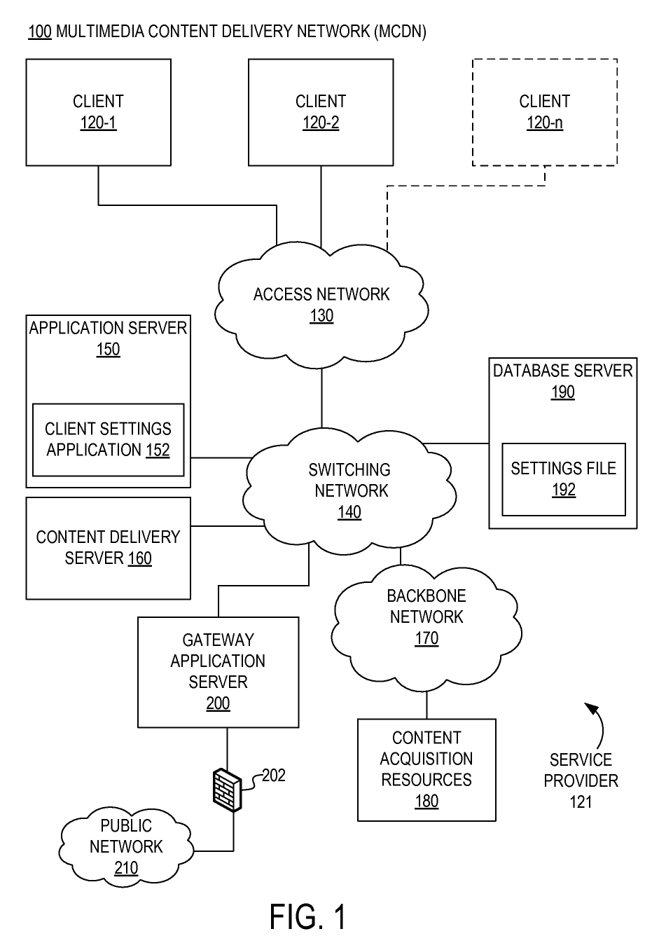

Turning now to the drawings, FIG. 1 is a block diagram illustrating selected elements of an embodiment of an MCDN 100. Although multimedia content is not limited to TV, Video on Demand (VOD), or Pay per View (PPV) programs, the depicted embodiments of MCDN 100 and its capabilities are primarily described herein with reference to these types of multimedia content, which are interchangeably referred to herein as multimedia content, multimedia content program(s), multimedia programs or, simply, programs or content.

The elements of MCDN 100 illustrated in FIG. 1 emphasize functionality for delivering multimedia content to a set of one or more users. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120, a service provider 121, and an access network 130 communicatively coupling the two. Each client 120 may represent a different user of MCDN 100. In FIG. 1, a plurality of n clients 120 are depicted as client 120-1, client 120-2 and client 120-n, where n may be a large number. Service provider 121 as depicted in FIG. 1 encompasses resources to acquire, process, and deliver programs and other features to clients 120 via access network 130. Such resources in FIG. 1 of service provider 121 include content acquisition resources 180, application server 150, database server 190, gateway application server 200, and content delivery server 160, also shown connected to switching network 140.

Access network 130 demarcates clients 120 and service provider 121 and provides connection path(s) between clients 120 and service provider 121. In some embodiments, access network 130 is an IP compliant network. In some embodiments, access network 130 is, at least in part, a coaxial cable network. It is noted that, in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twist pair cables, fiber optic cables, or a combination thereof. MCDN 100 may include digital subscribe line (DSL) compliant twisted pair connections between clients 120 and a node (not depicted) in access network 130 while fiber, cable, or another broadband medium connects service provider resources to the node. In other embodiments, the broadband medium may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140, access network 130, or both may include elements of a DSL Access Multiplexer (DSLAM) that multiplexes many user DSLs to backbone network 170.

In FIG. 1, backbone network 170 represents a private network including, as an example, a fiber-based network to accommodate high data transfer rates. Content acquisition resources 180 as depicted in FIG. 1 include hardware and other resource for acquiring various types of content including broadcast content, and other “live” content including national content feeds, VOD content and PPV content.

As suggested above, the content provided by service provider 121 encompasses multimedia content that is scheduled in advance for viewing by clients 120 via access network 130. Such multimedia content, also referred to herein as “scheduled programming,” may be selected using an electronic programming guide (EPG). Accordingly, a user of MCDN 100 may be able to browse scheduled programming well in advance of the broadcast date and time, and may decide to select programs in advance of a viewing session. Some scheduled programs may be “regularly” scheduled programs, which recur at regular intervals or at the same periodic date and time (i.e., daily, weekly, monthly, etc.).

Acquired content, live or otherwise, is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, it is to be appreciated that different types of content may be acquired via different types of acquisition resources. Similarly, although FIG. 1 depicts a single content delivery server 160, different types of content may be delivered by different servers. Moreover, embodiments of MCDN 100 may include content acquisition and/or delivery resources in regional offices (not depicted) that are connected to switching network 140 or access network 130.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPG, DVR, VOD, or PPV programs, IPTV portal, digital rights management (DRM) servers, navigation/middleware servers, conditional access systems (CAS), remote desktop applications and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include client settings application 152, which, as will be described below, may enable a client or other end user to download or otherwise install an MCDN client settings interface and supporting documents for client 120.

Also depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In the depicted embodiment, database server 190 includes a data warehousing application, accessible via switching network 140, that can be used to record and access structured data, such as a settings file 192 for use in conjunction with client settings application 152.

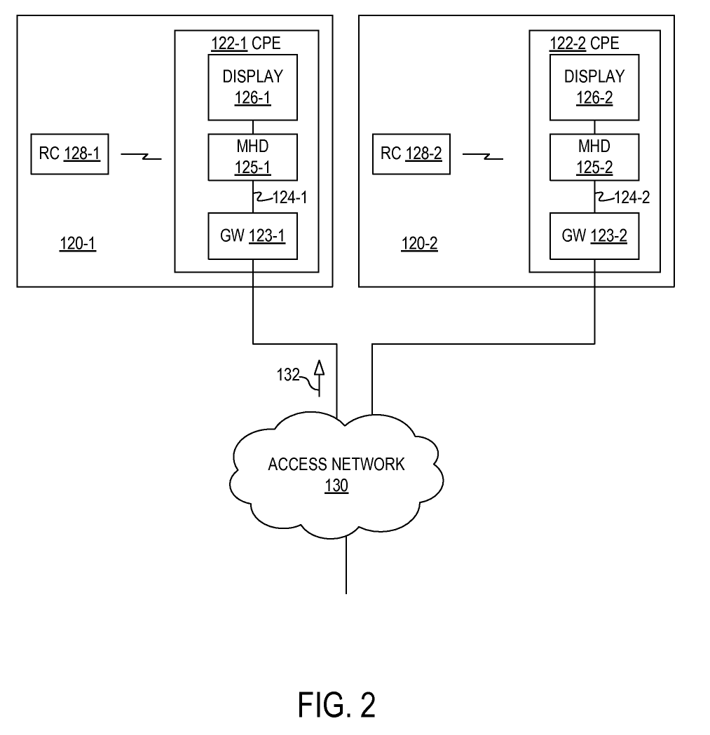

Turning now to FIG. 2, selected elements of an embodiment of a pair of MCDN clients 120 are shown. Clients 120 may include network appliances collectively referred to herein as CPE 122. In the depicted embodiment, CPE 122 includes a gateway (GW) 123, a set-top box or other type of multimedia handling device (MHD) 125, and a television, monitor or other type of display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate chassis or box.

In the embodiment depicted in FIG. 2, GW 123 provides connectivity between client 120 and access network 130 and enables client 120 to received multimedia content 132 from access network 130. In the depicted embodiment, GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device 126 or, more simply, display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more speakers (integrated or external) to play audio content.

Clients 120 as depicted in FIG. 2 include respective remote control (RC) device 128, which is configured to control the operation of MHD 125 by means of a user interface (not shown in FIG. 2) displayed on display 126. RC device 128 is operable to communicate requests or commands wirelessly to MHD 125 using infrared (IR), radio frequency (RF), or another form of local wireless technology signals. MHDs 125 may also receive requests or commands via buttons (not depicted) located on side panels of MHDs 125.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based MCDN.

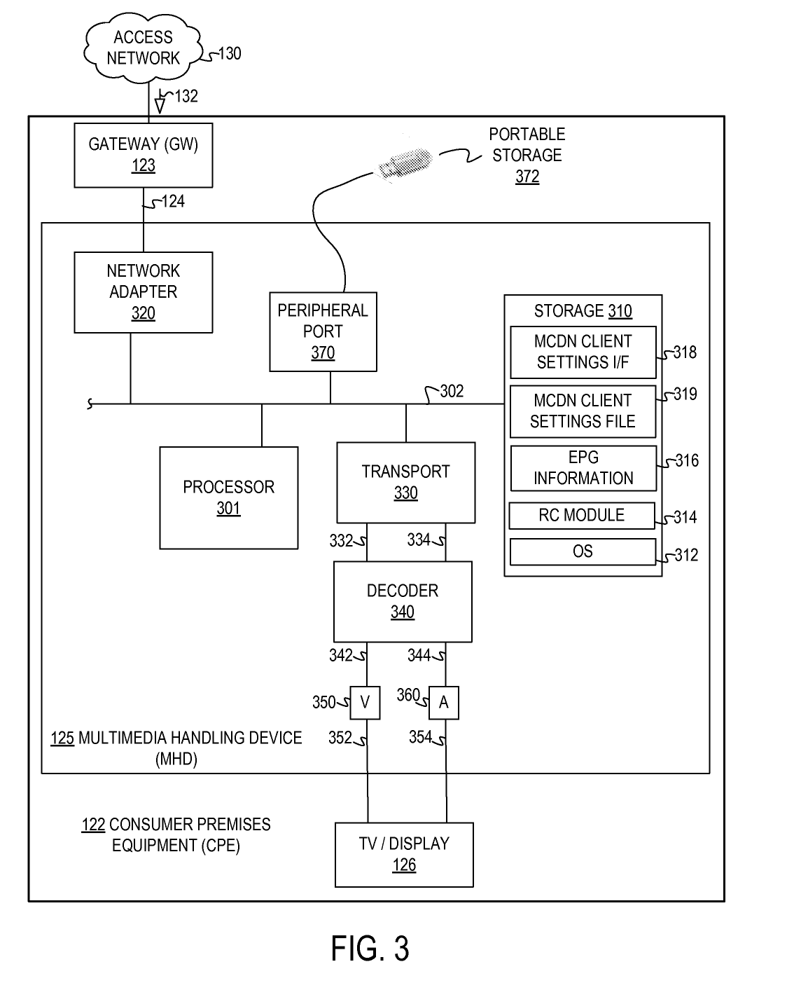

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2.

In the embodiment depicted in FIG. 3, MHD 125 includes processor 301 coupled via bus 302 to storage media collectively identified as storage 310. MHD 125, as depicted in FIG. 3, further includes network adapter 320 that interfaces MHD 125 to LAN 124 and through which MHD 125 receives multimedia content.

In embodiments suitable for use in IP-based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards or Windows Media Video (WMV) standards including WMV 9 which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 360 respectively to produce analog video and audio signals 352 and 354 in a format suitable for delivery to display 126, which itself may not be a part of MHD 125. Display 126 may comply with NTSC, PAL or any other suitable television standard.

Storage 310 encompasses all types of tangible media including persistent and volatile media, fixed and removable media, and magnetic and semiconductor media. Storage 310 is operable to store instructions, data, or both. Storage 310 as shown includes sets or sequences of instructions, including, an operating system 312, a remote control application program identified as RC module 314, EPG information 316, an MCDN client settings interface 318, and an MCDN settings file 319. Operating system 312 may be a UNIX or UNIX-like operating system, a Windows® family operating system, or another suitable operating system. In some embodiments, storage 310 is configured to store and execute instructions provided as services to client 120 by application server 150.

EPG information 316 represents a guide to the multimedia content provided via MCDN 100, and may be shown to a user as an element of a user interface. The user interface may include a plurality of menu items arranged according to one or more menu layouts, which enable a user to operate MHD 125. The user may operate the user interface, including EPG information 316, using RC device 128 (see FIG. 3) in conjunction with RC module 314.

In some embodiments, client settings application 152, possibly in conjunction with EPG information 316, MCDN client settings interface 318, and MCDN settings file 319, provides functionality to specify, modify, and transport user settings for MCDN client 120.

FIG. 3 as shown further depicts a form of portable storage 372, implemented with a conventional USB or other type of memory stick or thumb drive. Portable storage 372 as shown is connectable to a peripheral port 370. In some embodiments, portable storage 372 facilitates an aspect of the disclosed subject matter in which client settings are stored to portable device 372. A user may then physically transport portable storage 372 to a different or secondary MCDN client 120 (not depicted in FIG. 3) and connect portable storage 372 to an appropriate peripheral port of the secondary client 120. The secondary client 120 may then import client settings information from portable storage 372 and configure client 120 in accordance with the settings indicated by the settings data stored in portable storage 372.

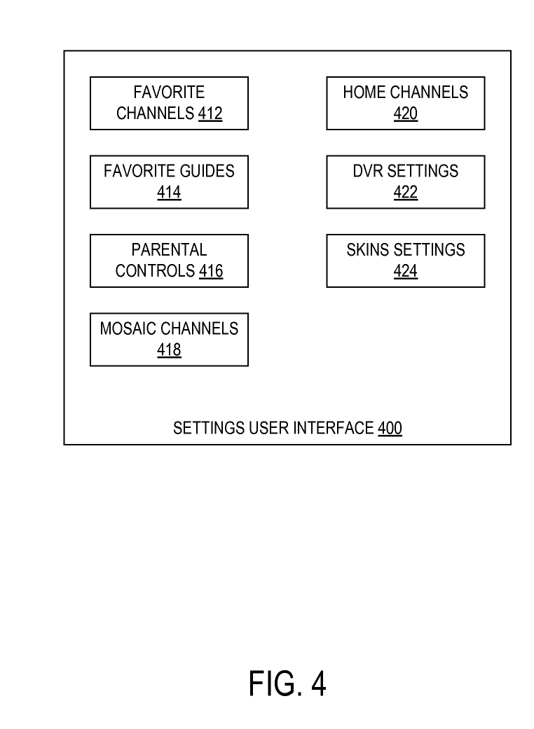

Turning now to FIG. 4, selected elements of one embodiment of a client settings user interface 400 are depicted. In the depicted embodiment, client settings user interface 400 includes a set of icons or other selectable element presented on a display screen when MCDN client settings interface 318 is invoked. Client settings user interface 400 may be displayed when the user of RC device 128 asserts a hardware button, touch screen soft button, or other type of control element of the RC device 128. Alternatively, client settings user interface 400 may be displayed when the user selects a “settings” option from another user interface.

As depicted in FIG. 4, client settings user interface 400 includes icons or other types of selectable graphic elements that enable the user to define at least some aspects of the manner in which an MCDN service as a whole or features of the MCDN service are presented to the user.

In the depicted embodiment, client settings user interface 400 includes icons for favorite channels 412, favorite guides 414, parental controls interface 416, Mosaid channel settings 418, home channels 420, DVR settings 422, and skins settings 424. Although FIG. 4 depicts these elements for client settings user interface 400 explicitly, other embodiments of client settings user interface 400 may include more, fewer, or a different combination of selectable elements.

In some embodiments, each of the icons 412 through 424 depicted in FIG. 4 is associated with and facilitates the modification and control of various features or aspects of MCDN client 120. In the depicted embodiment, favorite channels icon 412, when selected, may present the user with a list or other type of display of the user's defined channels. Favorite guides 414 may present the user with an interface for defining the manner in which one or more programming guides are presented to the user. Parental controls interface 416 may enable the user to define content restrictions and other parental supervision of the content that is accessible via the network.

Mosaic channels icon 418 as shown may present the user with an interface defining Mosaic settings. Mosaic settings define a group of two or more content channels that may be presented simultaneously to a viewer on one display screen. A user might, for example, define a Mosaic group of N movie channels, where N is an integer less than 10 or 20. When the user changes to the Mosaic channel, the user can simultaneously determine all of the movies that are currently accessible via the MCDN. In some embodiments, the Mosaic view is accessed by selecting a channel dynamically or statically assigned to the Mosaics feature. The Mosaics interface may enable the user to define the number of channels presented via the Mosaics interface, the identity of the channels depicted, and the MCDN channel dedicated to the Mosaics feature.

Client settings user interface 400 as depicted in FIG. 4 further includes a Home channels setting 420, which may enable the user to define one or more channels that is or are selected in response to a corresponding control element of RC device 128 or to a selection from a user interface. In the case of multiple home channels, the repeated selection of a home control element may rotate the displayed content through the set of home channels.

Client settings user interface 400 as depicted further includes a DVR settings icon 422. DVR settings icon 422 may provide access to a user's DVR settings in the form of channels and times for recording content provided via MCDN 100. The DVR settings accessible via DVR settings icon 422 may further include settings regarding how long recorded content is to remain, the number of episodes of any particular program that may be stored at any time, and rules for determining how to handle conflicts in DVR resources such as when a program identified by the DVR settings requires more storage capacity than the DVR system currently has available.

Client settings user interface 400 as depicted further includes a Skins settings icon 424. Skins settings icon 424 may enable the user to define various visual, textual, graphical, and/or audio elements of a particular client implementation. A skins setting accessible via skins settings icon 424 might include, for example, a setting for defining the color of the display background when a user guide, EPG, or other type of user interface is presented to the user. Skins settings icon 424 might further provide access to settings defining the default font for text information presented in an EPG or other interface and so forth.

Some embodiments of the disclosed subject matter may be implemented as a computer program product. A computer program product may be a form of a tangible, computer readable storage media that includes or in which are stored a set of one or more computer executable instructions. With respect to the subject matter disclosed herein, the computer executable instructions may include instructions for defining, modifying, transporting, and sharing a user's MCDN client settings. Computer program product implementations may be represented in the form of flow diagrams that depict the blocks or operations that might occur when a processor based or other type of computing device executes the instructions.

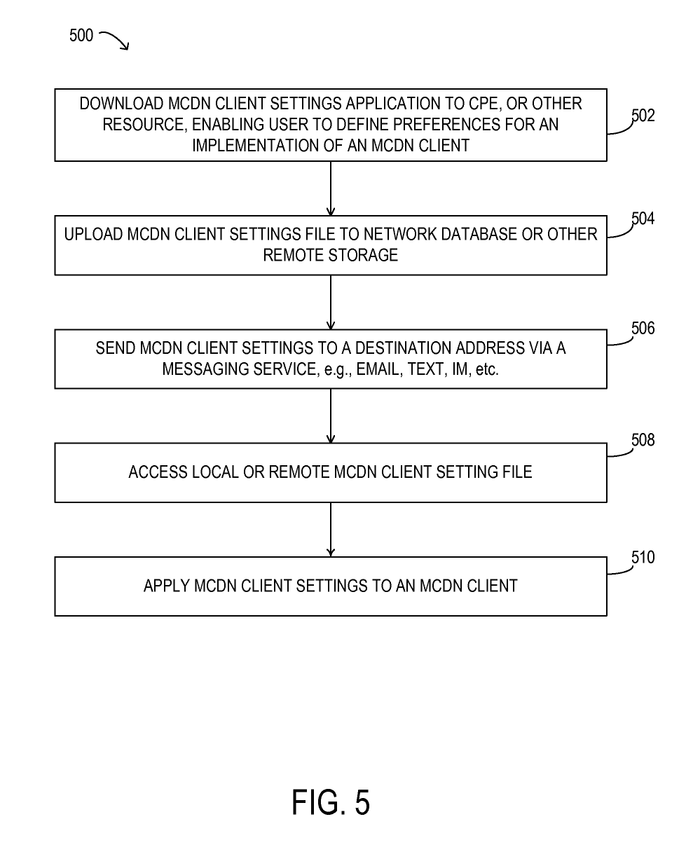

Referring now to FIG. 5, selected elements of an embodiment of method 500 for implementing user definable settings for an MCDN client application are depicted. Method 500 may represent operations performed by CPE 122, MHD 125, or another element of client 120. In the depicted embodiment, method 500 includes downloading (operation 502) client settings application 152 (FIG. 1). In other embodiments, instead of being downloaded, client settings application 152 may be referenced as an external document located, for example, on a remote server. In some embodiments, user definable client settings are provided as a value added feature for an MCDN 100. In these embodiments, the feature may be implemented by providing client settings application 152 as a downloadable application. A user of MCDN 100 that subscribes to or is otherwise authorized to implement a user-definable settings feature, downloads client settings application 152 from a networked server, such as the application server 150 depicted in FIG. 1. Client settings application 152, once downloaded and executed, may install MCDN client settings interface 318 and MCDN client settings file 319 to storage 310 of MHD 125. Client settings application 152, when executed by processor 301 of MHD 125, may provide the user with an MCDN client settings interface such as the client settings user interface 400 depicted in FIG. 4 enabling the user to define or modify user settings for an MCDN client implementation.

Method 500 as depicted in FIG. 5 emphasizes user-defined client settings as a service provided by an MCDN provider or a third party provider. Method 500 as depicted in FIG. 5 further includes uploading (operation 504) user preference settings to file in a network database or other type of remote storage. User-defined MCDN client settings might be uploaded, for example, to an MCDN client settings file 192 in a networked database 190 as depicted in FIG. 1. The ability to upload user-defined MCDN client settings to a database or other type of networked storage beneficially facilitates a portability feature of the service. More specifically, by uploading client settings file 192 to networked database server 190, the service or feature emphasized by method 500 facilitates the transporting of a user's defined settings from one location to another. In other embodiments, the user may be able to upload or store the client settings file 192 to local storage 310 in addition to or in lieu of storing client settings file 192 to database sever 190.

In still other embodiments, the portability of user defined MCDN client settings may be supported through various types of messaging services associated with or independent of MCDN 100. For example, MCDN 100 may include a gateway application server 200 (FIG. 1) that supports one or more forms of messaging capability for clients 120. Supported messaging capabilities may include email messaging, text messaging, instant messaging, and so forth. Messaging may be restricted among subscribing clients of MCDN 100 or it may be open messaging such that, for example, a user of client 120 may message anyone who has access to a public network 210 such as the Internet. In the depicted embodiment, a firewall 202 securing gateway application server 200 from public network 210 is shown.

Regardless of how messaging is implemented or supported within MCDN 100, method 500 may employ a supported messaging capability to provide a mechanism for transmitting or otherwise sending (operation 506) MCDN client settings information to a specified destination. The specified destination could be another user or user of MCDN 100 or a destination not associated with MCDN 100. The MCDN client settings information may be transported as a file or document attached to a corresponding message.

Method 500 as depicted in FIG. 5 further includes accessing (operation 508) an MCDN client settings file 319. The MCDN client settings file 319 could be located remotely, e.g., on networked database server 190, or locally, e.g., in storage 310 (FIG. 3) or on portable storage 372. The MCDN client settings file 319 may then be applied (operation 510) to an MCDN client implementation.

The operations of method 500 as depicted in FIG. 5 may be performed by a set top box or other type of CPE in an MCDN client 120. In these embodiments, for example, the operation 502 may refer to a set top box downloading an MCDN client settings application 152 from application server 150, operation 504 may represent the set top box uploading the MCDN client settings that are currently active to a networked database server such as database 190, operation 506 may refer to the set top box initiating an email, instant message, or other type of messaging server to send a file or document to another user or to another destination, operation 508 may refer to the set top box accessing locally or remotely stored MCDN client settings files, and operation 510 may refer to a client 120 modifying its configuration based on a settings file that the set top box has modified locally, downloaded from a remote location, received via email, and so forth. If two or more set top boxes or other forms of CPE within MCDN 100 share similar capabilities, the operations enumerated in method 500 enable the two or more clients to modify, share, and transport MCDN client settings freely.

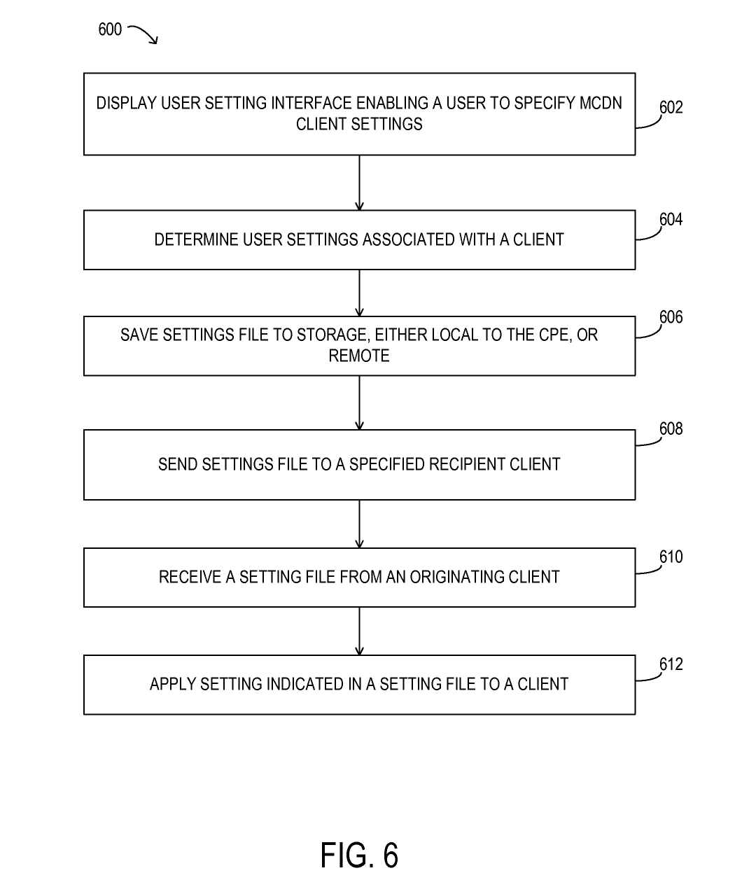

Referring now to FIG. 6, depicted are selected elements of an embodiment of a method 600 emphasizing aspects of the disclosed subject matter from the perspective of a client-side user of an MCDN client settings application such as MCDN client settings interface 318 (FIG. 3). The depicted embodiment of method 600 includes displaying (operation 602) an MCDN client settings interface enabling the user to specify MCDN client settings. Operation 602 may occur in response to the user asserting a control element such as a hardware button or a touch screen element on a RC device 128. Operation 602 may also occur in response to the user selecting an element on a different user interface presented by MCDN 100. For example, MCDN 100 may include an EPG, represented in FIG. 3 by block 316. In some embodiments, EPG information 316 may include an element enabling the user to transition from the EPG screen to the MCDN client settings interface by selection of an appropriate element on the EPG screen itself.

Method 600 as depicted in FIG. 6 further includes determining (operation 604) user settings associated with a particular implementation of an MCDN client 120 and saving (operation 606) the settings that were determined in operation 604 to storage that is local to a set top box or other form of CPE performing operation 606, storage that is remote, or both (i.e., saving to two different storage locations). FIG. 6 further illustrates the sending (block 608) of an MCDN client settings file to a specified MCDN client or other recipient. In some embodiments, the settings file may be delivered to another MCDN user using a buddy list or similar feature. Alternatively, as discussed above, MCDN client settings files may be distributed via more traditional messaging services including emails, text messages, and instant messages.

Operation 610 represents a set top box or other form of CPE receiving an MCDN client settings file from an originating location, for example, from a different MCDN client. In some embodiments, the destination and origin of an MCDN settings file that is transmitted via a messaging service may belong to the same user. For example, a user may wish to implement their existing MCDN client settings on a new client when a new television or display screen is acquired. Similarly, a user may wish to message or otherwise send its MCDN client settings file to a summer vacation home, a hotel during a business stay, and so forth. In these embodiments, the ability to deliver MCDN client settings to a remotely located client enables the user to recreate MCDN client settings that would be confusing and time consuming. This feature may be supplemented with a channel mapping application in which a user's channel guide is mapped onto a channel guide in a remote location so that the user may access familiar channel numbering when on the road.

Method 600 further illustrates a user's set top box or other form of CPE applying (operation 612) the settings indicated in an MCDN client settings file to a specific instance or implementation of an MCDN client, e.g., the MCDN client instance associated with the CPE itself.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A portable settings service for use in conjunction with a multimedia content distribution (MCD) service, comprising:
enabling a user to define settings for aspects of a multimedia content delivery network (MCDN) client;
responsive to a request, storing the defined settings to a settings file;
enabling the user to designate any of a plurality of MCDN clients; and
responsive to the user designating one of the plurality of MCDN clients, applying settings in the settings file to the designated MCDN client.

2. The service of claim 1, further comprising:
providing a user interface enabling the user to modify the defined settings.

3. The service of claim 2, wherein:
providing the user interface enables the user to modify the defined settings while interacting with a first customer premises equipment (CPE); and
enabling the user to designate any of a plurality of MCDN clients comprises enabling the user to designate a second CPE that is different than the first CPE.

4. The service of claim 1, wherein the storing comprises at least one of storing to a network storage device and storing to CPE storage.

5. The service of claim 1, wherein enabling the user to designate comprises enabling the user to send the settings file to the designated MCDN client via a messaging service of the MCD service.

6. The service of claim 5, wherein the messaging service is selected from the list consisting of an email service and an instant messaging service.

7. The service of claim 1, wherein the defined settings include user settings selected from a group of settings consisting of: favorite channel settings, favorite guide settings, parental control settings, mosaic channel settings, home channel settings, digital video recorder (DVR) settings, and skin settings indicative of settings for background images and color schemes.

8. The service of claim 1, wherein the applying comprises applying a user defined subset of the settings in the settings file.

9. Tangible and computer readable storage including computer executable instructions for implementing a portable preferences feature in conjunction with a multimedia content distribution (MCD) service, the storage including instructions for:
defining settings, based on user input, indicative of user preferences for aspects of the MCD service;
storing the defined settings to a settings file;
applying settings in the settings file to a designated client.

10. The service of claim 9, wherein the instructions for defining the settings comprise instructions for:
generating and displaying a settings-specific user interface; and
interpreting user interaction with the settings-specific user interface to modify the settings.

11. The service of claim 9, wherein the settings include settings selected from a group of settings consisting of: favorite channel settings, favorite guide settings, parental control settings, mosaic channel settings, home channel settings, digital video recorder (DVR) settings, and skin settings indicative of settings for background images and color schemes

12. The service of claim 9, wherein storing the defined settings to the settings file includes storing the defined settings to local storage within a client-side customer premises equipment.

13. The service of claim 9, wherein storing the defined settings to the settings file includes storing the defined setting to networked storage.

14. The service of claim 9, wherein said defining comprises defining with the designated client.

15. The service of claim 9, wherein said defining comprises defining with a different client than the designated client.

16. A method of implementing a multimedia content delivery (MCD) service, the method comprising:
enabling a client to receive a user settings module from an application server;
enabling the client to invoke the user settings module to define user preferences;
storing the user preferences to a settings file; and
responding to an import settings request from one of the plurality of client devices, downloading the settings file to a client device issuing the request and applying the settings to a client implementation of the client device.

17. A customer premises equipment (CPE) in a multimedia content distribution network (MCDN), the CPE comprising:
a network adapter for receiving multimedia content from the MCDN;
a multimedia decoder to decode multimedia content received from the MCDN;
a processor; and
tangible computer readable storage media, accessible to the processor, including processor executable instructions to:
display a user settings interface operable to specify user settings associated with an MCDN client;
determine the user settings specified for the MCDN client and generate a settings file indicative of the user settings;
save the settings file to storage;
send the settings file to a designated client;
receive a settings file from an originating client; and
apply settings indicated in the received settings file to the designated client based on the settings.

18. The CPE of claim 17, wherein the CPE comprises a set top box suitable for receiving the multimedia content via an Internet protocol television network.

19. The CPE of claim 17, wherein the settings include settings selected from a group of settings consisting of: favorite channel settings, favorite guide settings, parental control settings, mosaic channel settings, home channel settings, digital video recorder settings, and skin settings indicative of settings for background images and color schemes.

20. The CPE of claim 17, wherein the instructions for sending comprise instructions for sending the settings file to the specified client as an attachment to an electronic message.
